(19) United States
(12) Patent Application Publication
(10) Pub. No.: US 2023/0263307 A1
(43) Pub. Date: Aug. 24, 2023

(54) REMOVABLE SEATING ASSEMBLY FOR VEHICLE CARGO AREA

(71) Applicant: Josh LaViolette, Los Angeles, CA (US)

(72) Inventor: Josh LaViolette, Los Angeles, CA (US)

(21) Appl. No.: 18/110,065

(22) Filed: Feb. 15, 2023

Related U.S. Application Data
(60) Provisional application No. 63/312,473, filed on Feb. 22, 2022.

(51) Int. Cl. A47C 3/16

(52) U.S. Cl. CPC A47C 3/16

(57) ABSTRACT

The present invention is directed to a removable seating assembly for the cargo area of a vehicle. The assembly comprises a support base adapted to fit with the recess of a vehicle cargo area and a cushion adapted to rest on and be support by the support base. In a preferred embodiment the cushion is curved and the cushion edges extends laterally beyond the top surface of the support base. The assembly can support the weight of a human. Preferably, the cargo area is a front trunk of a vehicle.

The present invention is directed towards a removable seating assembly for the cargo area of a vehicle. The seating assembly comprises a removable support base adapted to fit with the recess of a vehicle cargo area and a removable cushion adapted to rest on and be support by the support base. In a preferred embodiment the cushion is curved and the cushion edges extends laterally beyond the top surface of the support base. The assembly can support the weight of a human. Preferably, the cargo area is a front trunk of a vehicle.

Upon further study of the specification, figures and claims, further objects and advantages of this invention will become apparent to those skilled in the art.

### BRIEF DESCRIPTION OF THE DRAWINGS

Various features and attendant advantages of the present invention will be more fully appreciated as the same becomes better understood when considered in conjunction with the accompanying drawings, in which like reference characters designate the same or similar parts throughout the several views, and wherein:

FIG. 1A depicts a top view of a seating assembly embodiment of the present invention adapted to fit within a TESLA MODEL 3™.

FIG. 1B depicts a front view of a seating assembly embodiment of the present invention adapted to fit within a TESLA MODEL 3™.

FIG. 1C depicts a side view of a seating assembly embodiment of the present invention adapted to fit within a TESLA MODEL 3™.

FIG. 2A depicts a top view of a TESLA MODEL 3™ front trunk cargo area tub.

FIG. 2B depicts a front view of a TESLA MODEL 3™ front trunk cargo area tub.

FIG. 2C depicts a side view of a TESLA MODEL 3™ front trunk cargo area tub.

FIG. 2D depicts a top view of a TESLA MODEL 3™ front trunk cargo area tub with a honeycomb base top surface.

FIG. 2E depicts a side view of a TESLA MODEL 3™ front trunk cargo area tub with a support base.

FIG. 2F depicts a side view of a with a honeycomb base frame with legs. The back of the support is shorter than the front of the support so as to accommodate the sloped surface of the cargo trunk and allow the base top surface to be approximately level.

FIG. 3 depicts a seating assembly embodiment of the present invention showing a cushion adapted to fit within a TESLA MODEL S™.

FIG. 4 depicts a seating assembly embodiment of the present invention showing a cushion adapted to fit within a TESLA MODEL X™.

FIG. 5 depicts a seating assembly embodiment of the present invention showing a cushion adapted to fit within a TESLA MODEL Y™.

FIG. 6A depicts a folding seating assembly cushion embodiment of the present invention.

FIG. 6B depicts the folding seating assembly cushion of FIG. 6A showing the front cushion panel (46) and the back cushion panel (47) in a folded-up position.

FIG. 7A depicts a seating assembly support base embodiment of the present invention showing a honeycomb type base top surface.

FIG. 7B depicts a seating assembly support base embodiment of the present invention showing a honeycomb type base top surface. The honeycomb type lid is in an open position.

FIG. 7C depicts a top view of seating assembly support base embodiment of the present invention showing a honeycomb type base top surface. The top surface is attached to the support base with hinges (29).

FIG. 8A depicts a seating assembly support base embodiment of the present invention showing a frame type support base.

FIG. 9A depicts a seating assembly support base embodiment of the present invention showing a cooler type support base.

FIG. 9B depicts a seating assembly support base embodiment of the present invention showing a cooler type support base with one half of the lid open.

FIG. 9C depicts a top view of a seating assembly support base of FIG. 9A.

FIG. 10A depicts a seating assembly support base embodiment of the present invention showing a camp cot type support base.

FIG. 10B depicts a seating assembly support of FIG. 10A showing the legs (24) of the camp cot type support base in a folded position.

FIG. 11A depicts a cooler type support base embodiment of the present invention and a cushion embodiment of the present invention.

FIG. 11B depicts a frame type support base embodiment of the present invention and a cushion embodiment of the present invention.

FIG. 11C depicts a honeycomb type support base embodiment of the present invention and a cushion embodiment of the present invention.

FIG. 12A depicts a frame type support base embodiment of the present invention and a folding cushion embodiment of the present invention.

FIG. 12B depicts a support base embodiment of the present invention and a folding cushion embodiment of the present invention.

FIG. 12C depicts a frame type support base embodiment of the present invention and a curved cushion embodiment of the present invention.

FIG. 13 depicts a top view of a TESLA MODEL Y™ front trunk cargo area tub.

FIG. 14A depicts a top view of a FORD F150 LIGHTNING™ front trunk cargo area tub.

FIG. 14B depicts a front view of a FORD F150 LIGHTNING™ front trunk cargo area tub.

FIG. 15A depicts a top view of a TESLA MODEL S™ front trunk cargo area tub.

FIG. 15B depicts a front view of a TESLA MODEL S™ front trunk cargo area tub.

FIG. 15C depicts a side view of a TESLA MODEL S™ front trunk cargo area tub.

### DESCRIPTION OF THE INVENTION

Cargo area means “the luggage, storage or cargo compartment of an automobile.” The term trunk is synonymous with cargo area. Newer model cars often have a storage space in the front and the back, the term “frunk” has emerged to mean an enclosed storage compartment located near the front of the vehicle. Such compartments are meant to be analogous to a trunk, which is traditionally located in the car's rear. Thus, while the term truck is a reference to both front and rear cargo storage areas, a Frunk is specifically a front storage trunk. The term has become popular as more and more cars (in particular, electric cars) are designed without needing the space to accommodate the traditional front-mounted gasoline engine.

The British often used the term “boot” synonymously with trunk. Thus, a “froot”—a blend of ‘front’ and ‘boot”—is synonymous with “Frunk”.

The dimensions of a Frunk or Trunk would depend upon the vehicle make, model and year. Currently, numerous electric vehicles are on the market, for example, TESLA MODEL S, FORD MUSTANG MACH-E ELECTRIC SUV, FORD F 150 ELECTRIC TRUCK, PORSCHE BOXSTER, AUDI R8, JAGUAR I-PACE, PORSCHE 911, TESLA MODEL 3, TESLA MODEL X, LAMBORGHINI AVENTADOR, BMW I3, BUGATTI CHIRON, FERRARI 488GTB, LAMBORGHINI HURACAN, LAMBORGHINI AVENTADOR, MCLAREN 570 GT/570S, MCLAREN 720S, PORSCHE 718 BOXSTER/718 CAYMAN, AUDI A6 E-TRON, BMW IX, BYTON M-BYTE, CADILLAC LYRIQ, CHEVROLET SILVERADO ELECTRIC, DODGE EMUSCLE, FARADAY FUTURE FF91, FORD EXPLORER EV, HONDA PROLOGUE, JEEP WRANGLER MAGNETO EV, KIA EV6, LAGONDA EV, LEXUS EV SUV, LINCOLN SUV EV, MAZDA MX-30, MERCEDES-BENZ EQA, NISSAN ARIYA, POLESTAR 3, SUBARU SOLTERRA AND TOYOTA BZ4X. Additional electric vehicles are entering the market at a rapid pace.

Not all electric vehicles have a cargo area (truck or frunk) that is sufficiently sized to accommodate a support base. However, one skilled in the art can, using the preceding and following description and drawings, contemplate the spirt of the present invention to its fullest extent. The 2021 Tesla Model S has about 5 cubic feet of storage space underneath the hood (frunk). The Tesla Model 3 frunk is able to fit a small suitcase within the frunk space whereas an Audi R8 can fit just one carry-on suitcase. A Porsche 911 has 9.3 cubic feet of frunk space which can fit two hand-drawn suitcases while a Porsche Boxster frunk space can fit up to two carry-on suitcases. The Lamborghini Aventador frunk has about 5.3 cubic feet of storage space. Thus, the dimensions of the support base must be adapted to fit within the specific vehicle cargo space.

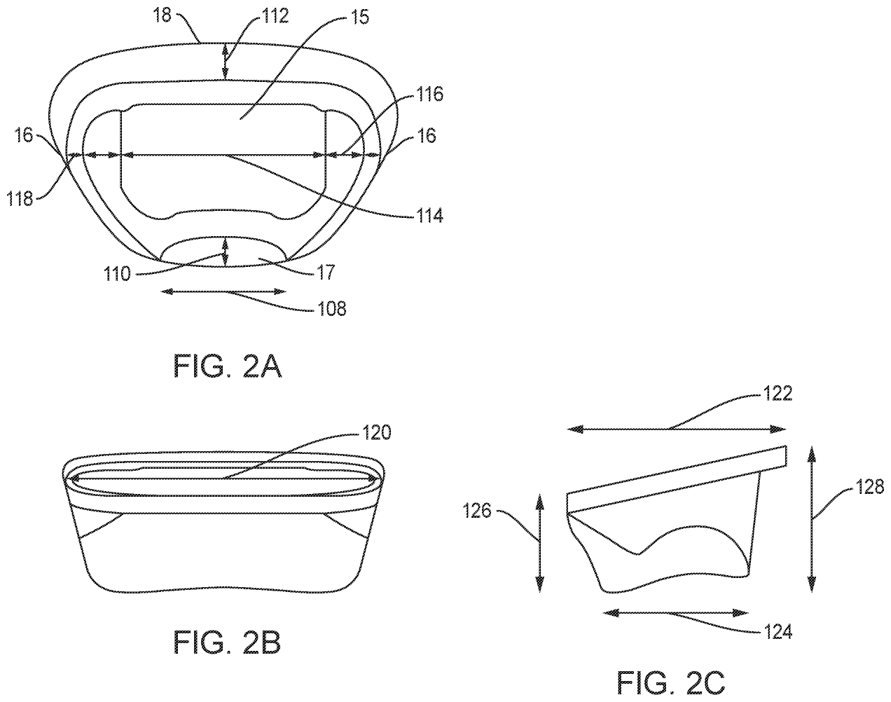

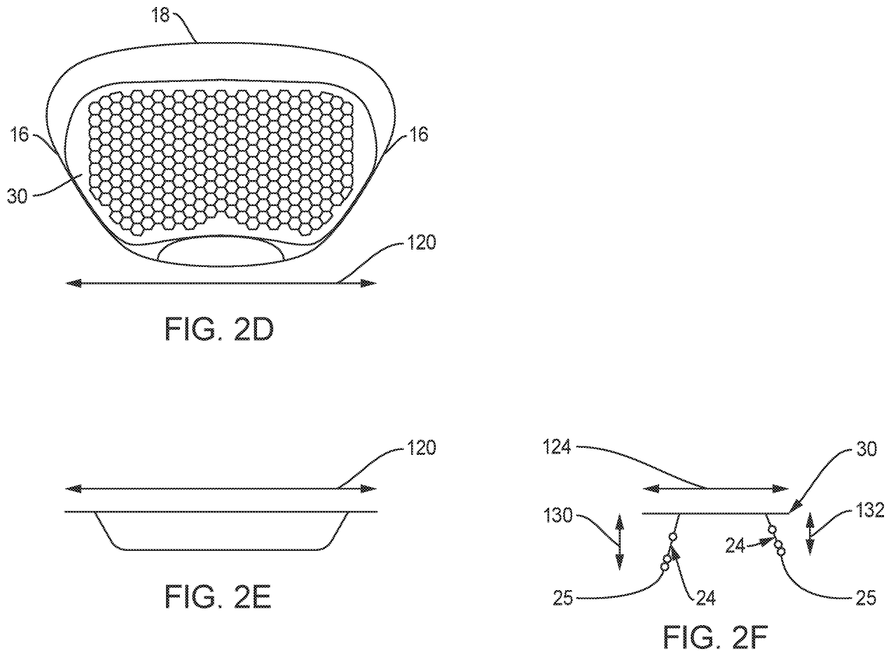

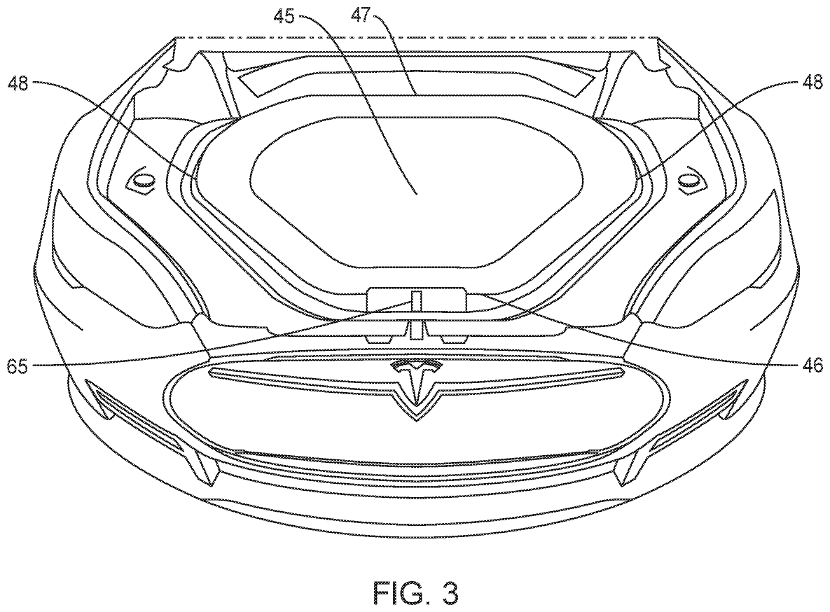

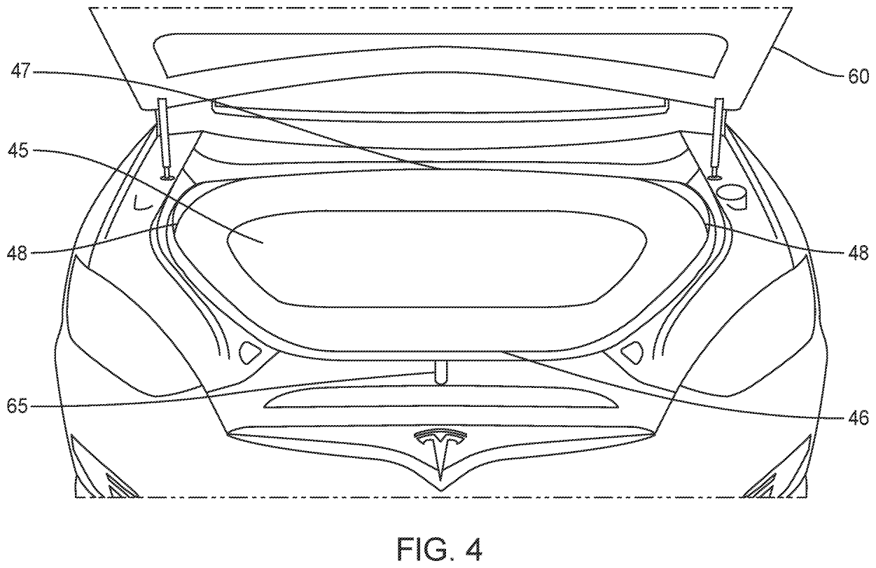

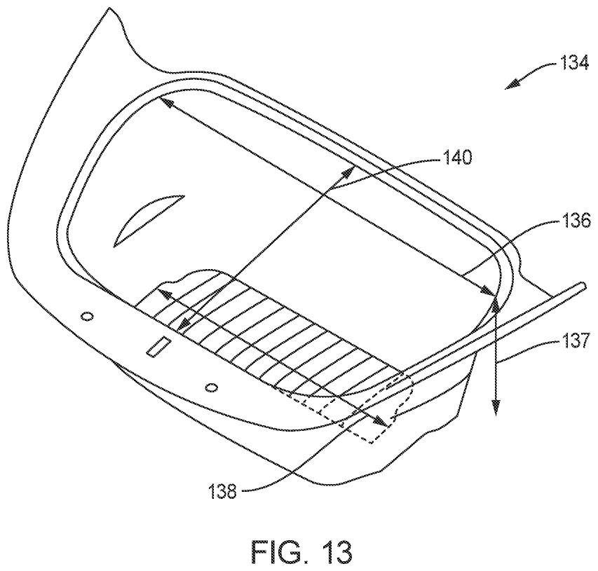

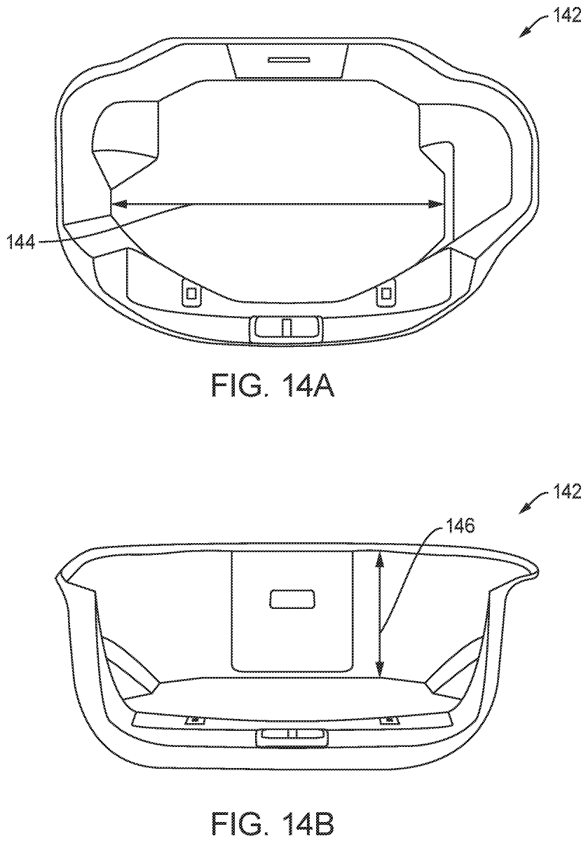

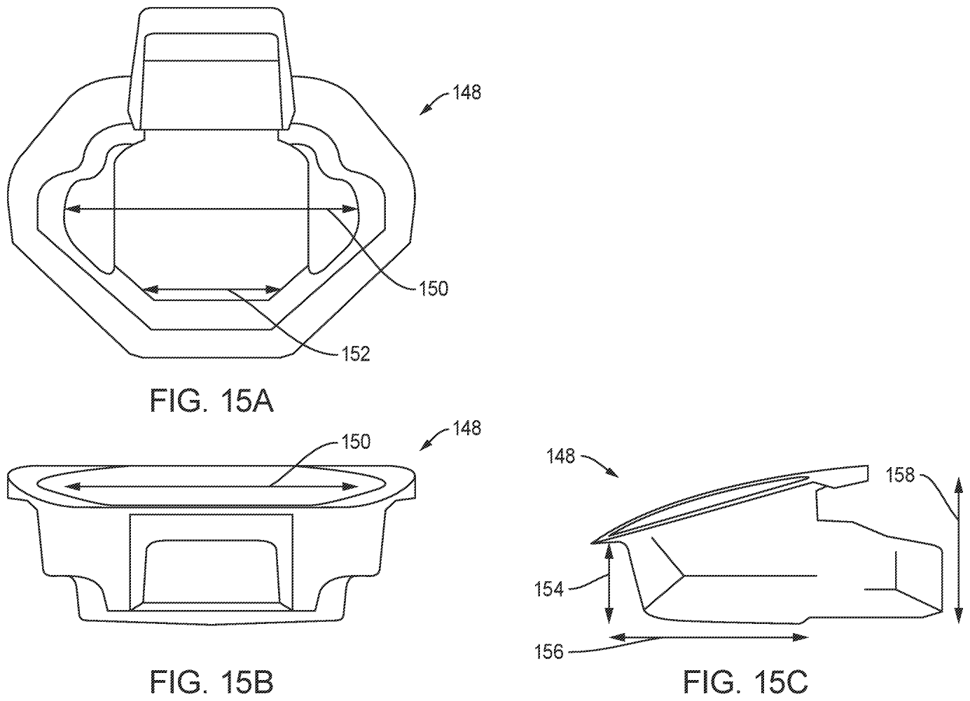

A typical cargo area frunk is depicted in FIGS. 2A, 2B and 2C which show top, front and side views of a TESLA MODEL 3™ front trunk cargo area tub. As can be seen, the cargo area tub has a stepped recessed central area, the floor of which is slightly higher on the backside of the cargo area. The bottom of the cargo area (114) is about 28.5 inches. The first stepped area (116) is about 5 inches and the upper most stepped area (118) is about 2 inches. The top side of the tub is about 23 inches (122) from backside to front side while the bottom side of the tub is about 14 inches (124) from backside to front side. FIG. 2D depicts a top view of a support base top surface adapted to fit within the recessed cargo area. The support base top surface (30) is about 33 inches (120) extending from fender side (16) to fender side and about 14 inches (124) extending from backside (31) to base bumper side (32). In FIG. 2F the back legs (24) of the support base are 5 inches and the front legs of the support base are 6.5 inches. The bottom surface (25) of the support base legs (24) rest upon the cargo area floor (15). While the drawings in the present application, depict various Tesla Models as examples one skilled in the art would recognize that the claimed invention can be adapted to the dimensions of other vehicle cargo spaces and in particular to vehicle frunks (or froot). See, for example, FIGS. 13, 14 and 15. FIG. 13 depicts a top view of a TESLA MODEL Y™ front trunk cargo area tub. The top surface of the tub is about 16.9 inches (140) from front to back. The tub is about 35.8 inches across (136) from fender side to fender side. The backside of the tub is about 13.8 inches deep (137). FIG. 14A depicts a top view of a FORD F150 LIGHTNING™ front trunk cargo area tub. At the widest portion, the tub is about 50 inches across (144). FIG. 14B depicts a front view of a FORD F150 LIGHTNING™ front trunk cargo area tub. The back of the tub is about 29 inches deep (146). FIG. 15A depicts a top view of a TESLA MODEL S™ front trunk cargo area tub. At the widest point, the tub is about 39 inches across (150) and at the point closest to the hood latch the cargo area is about 17 inches across (152). FIG. 15B depicts a front view of a TESLA MODEL S™ front trunk cargo area tub. FIG. 15C depicts a side view of a TESLA MODEL S™ front trunk cargo area tub. The cargo area is about 15 inches deep (158) towards the back of the cargo area opening and cargo area is about 7 inches deep (154) towards the front of the cargo area opening. Thus, the support base must be adapted to fit within the cargo areas of the various vehicle makes and models.

By cushion herein is meant, a shock absorbing resilient pad with a soft or resilient filling, used for support while resting or reclining. The most common cushion fillings are feathers, foam, polyester, hollow-fill fiber, sponge rubber, shredded foam, batting, natural latex rubber foam, gel enhanced foams, or air. In certain embodiments the cushion is inflatable. In certain embodiments the cushion is made with polystyrene beads, buck heat hulls or expanded polystyrene beads such as used in a traditional bean bag. There are many types of fillings and materials that can be used for cushions. Some make the cushion soft and comfy while other materials give cushions a firm and supportive structure. Molded foam, all-foam, spring down or blend down can be used. These foams all range from high density to low and memory foam. Each of the uses can differ, depending on what kind of support and softness is required. Low-density foam cushion has a softness to it that tends to flatten faster, unless it is of a high quality. High-density foam filling is a little hard, but tends to get softer with time and weight. Memory foam conforms to the body and provides great support. High-resilient density (HR) foam is resistant to sagging and wearing. The cushions may contain a mixture of padding material.

In a preferred embodiment, the foam cushion is made from high density ultra 2.5 firm foam, having a density of 2.5 and a firmness of 45. It is a flexible polyurethane foam (FPF) with a chemically open cell polymeric complex having a broad range of load bearing capability and resiliency. Also preferred are high density ultra-med firm foams having a density of 2.5 and a firmness of 35. Also preferred are latex foams. Such foams are commercially available from, for example, FOAMMART.

In certain embodiments the cushions have internal supports to provide additional stiffness to selected parts of the cushion. In certain embodiments the cushions have internal supports in selected parts of the cushion to provide additional stiffness to the back support portion of the cushion.

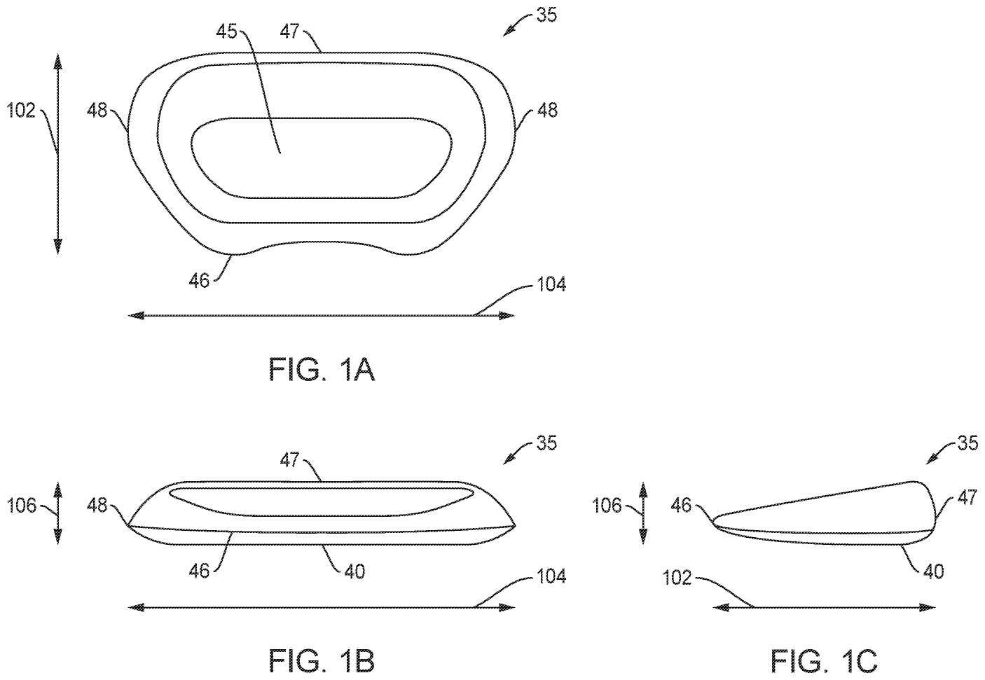

In a preferred embodiment such as shown in FIG. 1, the cushion (35) is thicker (i.e., about 5 inches) at the cushion back side (47) and thinner (i.e., about 2 inches) at the cushion bumper side (32). The cushion is about 33 inches from fender side to fender side (48) and 14 inches from cushion back side (47) to cushion bumper side (46).

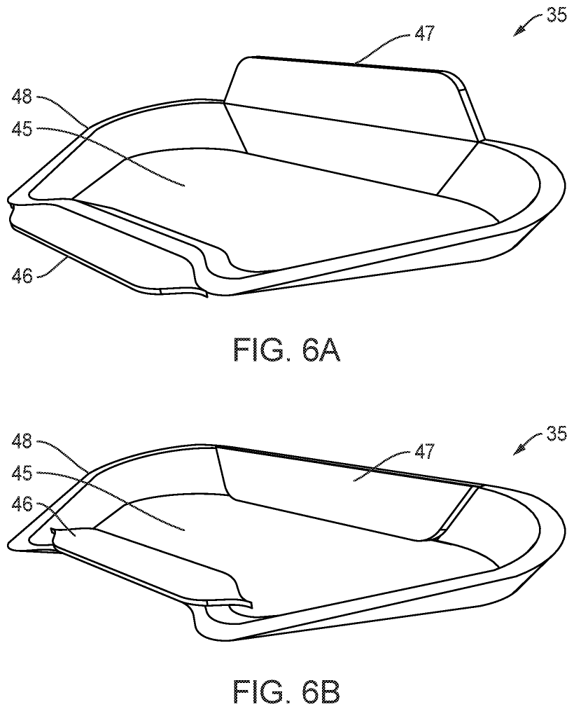

Preferably, the cushion extend to cover the entire open of the cargo area (e.g., from fender side (48) to fender side (48) and from cushion back side (47) to cushion bumper side (46). In certain embodiments (e.g., FIGS. 6A and 6B) the cushion extends beyond the opening of the cargo area and portions of the cushion are foldable so that in a folded position the cargo lid can close.

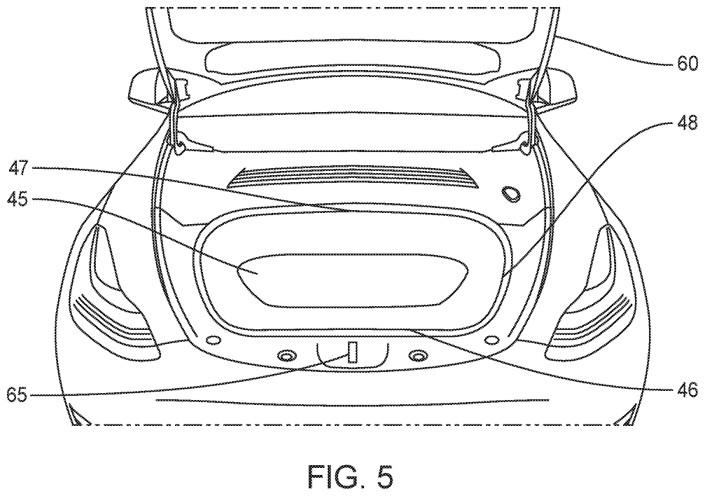

FIG. 3 depicts a seating assembly embodiment of the present invention showing a cushion adapted to fit within a TESLA MODEL S™. FIG. 4 depicts a seating assembly embodiment of the present invention showing a cushion adapted to fit within a TESLA MODEL X™. FIG. 5 depicts a seating assembly embodiment of the present invention showing a cushion adapted to fit within a TESLA MODEL Y™. As can be seen in FIGS. 3, 4 and 5 the shape and size of the cushion is adapted to the shape and size of the cargo area. The cushion embodiments depicted in FIGS. 3, 4 and 5 are of a size and thickness that allows the trunk cover to be closed and latched with the cushion in place.

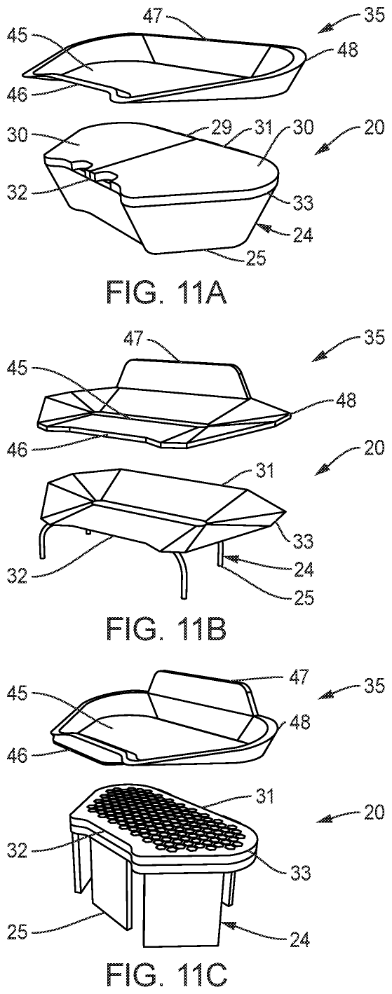

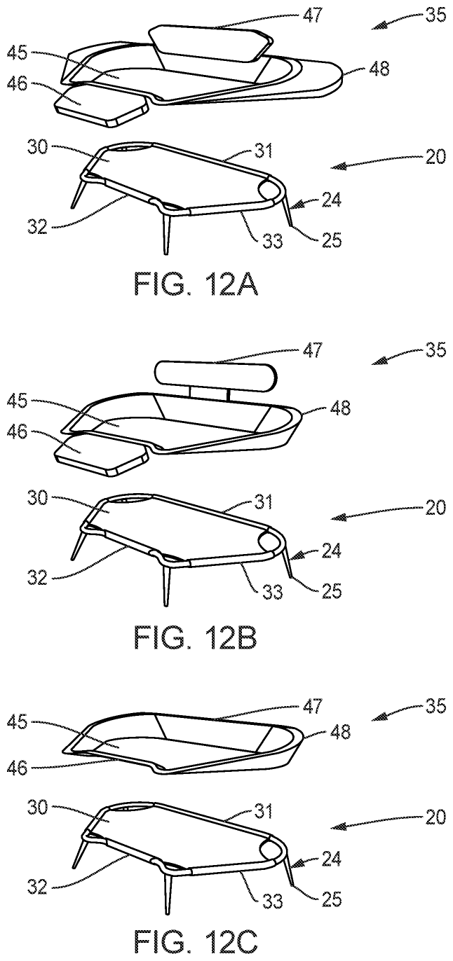

FIG. 6A and FIG. 6B depict a folding seating assembly cushion embodiment of the present invention showing the cushion backside (47) and cushion bumper side (46) portions of the cushion which can fold inward to accommodate a closed frunk or trunk hood and can fold outward when in use. FIGS. 11a, 11b, 11c, 12a, 12b and 12c depict additional cushion embodiments.

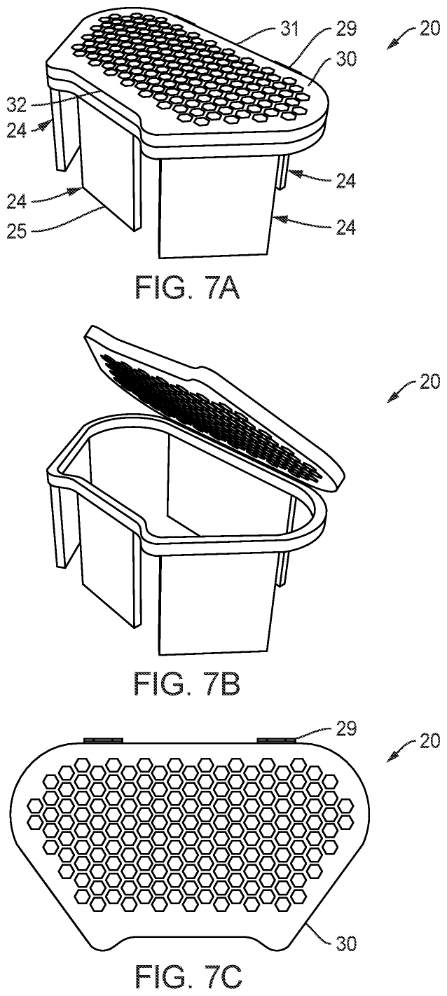

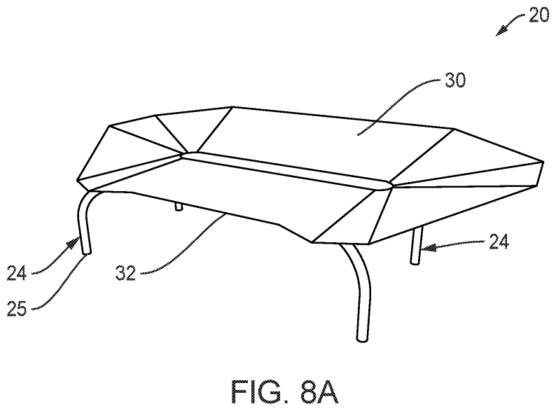

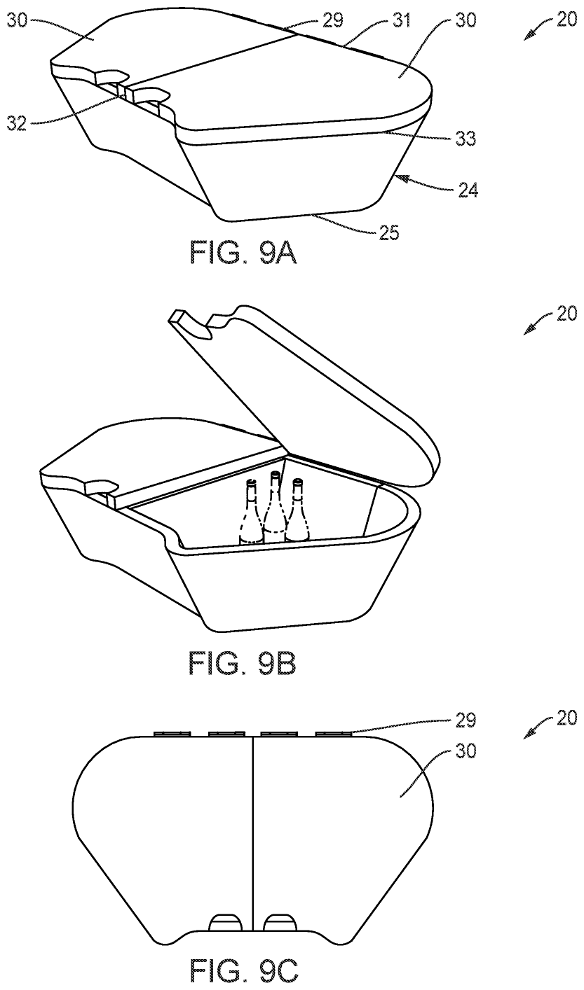

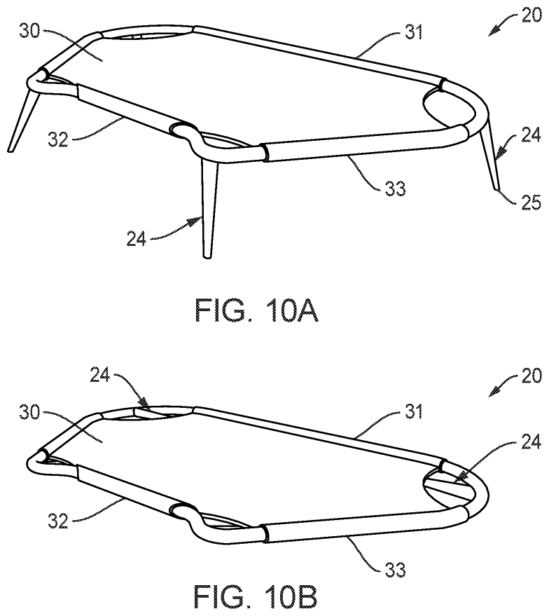

Support base herein means any base adapted to fit with the cargo area which is sufficient to support a cushion and the weight of a human body. Preferably the base is of a height that elevates the cushion to a level that is above the height of the latch area but still allows the trunk hood to be closed. FIGS. 7A, 7B and 7C depict a seating assembly support base embodiment of the present invention showing a honeycomb type base top surface. The support base in this embodiment is panels or legs (24). The bottom of the legs (25) rest upon the floor of the cargo area. The honeycomb lid can be attached to the support base via hinges (29) or can simply rest upon the support base legs. FIG. 8A depicts a seating assembly support base embodiment of the present invention showing a frame type support base. FIGS. 9A, 9B and 9C depict a seating assembly support base embodiment of the present invention showing a cooler type support base. The cooler lid can be one piece or two pieces as shown in FIG. 9A, 9B or 9C. FIGS. 10A and 10B depict a seating assembly support base embodiment of the present invention showing a camp cot type support base. The legs (24) are foldable as seen in FIG. 10B. Additional support base embodiments can be seen in FIGS. 11a, 11b, 11c, 12a, 12b and 12c.

In certain embodiments the base can be folded when not in in use e.g., FIG. 10B. In certain embodiments the base top surface is connected to the base bottom surface via a hinge (29) such as shown in FIG. 7C.

The base (20) can be made from a variety of materials such as plastic, metal or wood. Aluminum sheeting is lightweight and can be cast, molded or finished in a variety of conventional ways. FIGS. 7A, 7B and 7C depict a seating assembly support base embodiment of the present invention showing a honeycomb type base top surface. In this embodiment the base as several legs (24) which extend to the cargo area floor (15). The bottom of the legs (25) rest upon the cargo area floor. FIG. 8A depicts a seating assembly support base embodiment of the present invention showing a frame type support base. The frame can be a conventional aluminum or steel tubing FIGS. 9A, 9B and 9C depicts a seating assembly support base embodiment of the present invention showing a cooler type support base. A cooler type base is preferably, made of an insulated molded plastic. Typical coolers are made from polystyrene or spray-foam walls with a thin blow-molded polypropylene (PP) plastic exterior. Some coolers have a thick molded polyethylene (PET) plastic shell that is then injected with polyurethane foam. FIGS. 10A and 10B depict a seating assembly support base embodiment of the present invention showing a camp cot type support base. Preferably, the cot type frame has a metal tubbing support with a taught canvas type fabric top surface.

The figures depict support bases and cushions which are separate. However, in certain embodiments of the present invention the cushion and support base may be one piece (not shown). The cushion may be permanently attached to the top of the support base or the cushion may be semi-permanently attached to the top of the support base. The top of the support base may be incorporated into the bottom of the cushion.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

The entire disclosures of all applications, patents and publications, cited herein and of U.S. Provisional Application Ser. No. 63/312,473, filed Feb. 22, 2022, are incorporated by reference herein.

The preceding embodiments can be repeated with similar success by substituting the generically or specifically described cushions and or support bases which are adapted to fit within vehicle cargo areas of vehicles other than those vehicles specifically exemplified.

From the foregoing description, one skilled in the art can easily ascertain the essential characteristics of this invention and, without departing from the spirit and scope thereof, can make various changes and modifications of the invention to adapt it to various usages and conditions.

1. A seating assembly for the removable attachment to a cargo area (trunk) of a vehicle comprising:
a) a removable support base having a bottom surface and a top surface, said support base adapted to fit within said cargo area,
and
b) a removable cushion having a bottom surface adapted to rest upon and be supported by said top surface of said support base
and
wherein the bottom surface of said support base rests upon and is supported by a floor of said cargo area.

2. The seating assembly of claim 1, wherein said cargo area is a front trunk (frunk) of a vehicle.

3. The seating assembly of claim 1, wherein a portion of said cushion extends laterally or upwardly beyond the top surface of the support base and supports the back of a human while in a seated position.

4. The seating assembly of claim 1, wherein said removable cushion extends laterally beyond the top surface of said support base in the direction of the side fender of a vehicle.

5. The seating assembly of claim 1, wherein said removable cushion extends laterally and upwardly beyond the top surface of said support base in the direction of the cargo area backside.

6. The seating assembly of claim 1, wherein said removable cushion fits within the cargo area of a vehicle while a trunk hood is in a closed and latched position.

7. The seating assembly of claim 1, wherein said removable cushion is foldable.

8. The seating assembly of claim 1, wherein said removable cushion is thicker on the cushion backside.

9. The seating assembly of claim 1, wherein said removable cushion is thicker on the cushion fender side.

10. The seating assembly of claim 1, wherein said removable cushion extends laterally beyond the top surface of said support base.

11. The seating assembly of claim 1, wherein the cushion back side of said removable cushion extends upwardly beyond the top surface of said support base.

12. The seating assembly of claim 1, wherein the support base is a cooler.

13. A seating assembly for the cargo area (trunk) of a vehicle comprising:
a) a support base having a bottom surface and a top surface, said support base adapted to fit within said cargo area,
and
b) a cushion having a bottom surface attached to and supported by said top surface of said support base
and
wherein the bottom surface of said support base rests upon and is supported by a floor of said cargo area.

14. The seating assembly of claim 13, wherein said cushion extends laterally beyond the top surface of said support base in the direction of the side fender of a vehicle.

15. The seating assembly of claim 13, wherein said cushion extends laterally and upwardly beyond the top surface of said support base in the direction of the cargo area backside.

16. The seating assembly of claim 13, wherein said cushion fits within the cargo area of a vehicle while a trunk hood is in a closed and latched position.

17. The seating assembly of claim 13, wherein the support base is a cooler.
